(19) United States
(12) Patent Application Publication
(10) Pub. No.: US 2023/0095792 A1
(43) Pub. Date: Mar. 30, 2023

(54) Budget Managing System

(71) Applicant: Dell Products, L.P., Round Rock, TX (US)

(72) Inventors: Betty Joyce Flowers, Austin, TX (US); Nancy Elaine Moore, El Paso, TX (US)

(21) Appl. No.: 17/491,042

(22) Filed: Sep. 30, 2021

(51) Int. Cl. G06Q 40/00; G06Q 20/10

(52) U.S. Cl. CPC G06Q 40/12; G06Q 20/102

(57) ABSTRACT

A system can maintain a status that corresponds to request data indicative of a request to acquire computing components. The system can validate program data representative of a program and budget data representative of a budget that correspond to the request data, validate configuration data representative of a configuration of hardware that corresponds to the request, validate that the request is within a scope of a project defined by project data and a project plan of the project defined by the project data, determine that funds for the request are available, and setting the value of the status to a budget approved status to indicate the budget has been approved, and assign an accounting code and a general ledger cost account for the request, and setting the value of the status to a finance approved status. The system can initiate an order for the computing components in an ordering system.

### BACKGROUND

Requests to allocation portions of a budget to acquire particular resources can be processed, and either accepted or rejected.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can, in response to receiving request data indicative of a request to acquire computing components, maintain a status that corresponds to the request data and setting a value of the status to planning. The system can, in response to determining that the value of the status being set to pending, validate program data representative of a program and budget data representative of a budget that correspond to the request data. The system can, after validating the program data, validate configuration data representative of a configuration of hardware that corresponds to the request. The system can, after validating the configuration data, validate that the request is within a scope of a project defined by project data and a project plan of the project defined by the project data. The system can, after validating that the request is within the scope of the project and the project plan, determine that funds for the request are available, and setting the value of the status to a budget approved status to indicate the budget has been approved. The system can, in response to determining that the value of the status is set to the budget approved status, assign an accounting code and a general ledger cost account for the request, and setting the value of the status to a finance approved status. The system can, in response to determining that the value of the status is set to the finance approved status, initiate an order for the computing components in an ordering system.

An example method can comprise validating, by a system comprising a processor, program data representative of a program and program data representative of a budget that correspond to request data indicative of a request to acquire computing resources. The method can further comprise, after validating the program and the budget, validating, by the system, a configuration of hardware that corresponds to the request. The method can further comprise, after validating the configuration, validating, by the system, that the request is within a scope of a project to which the request is applicable and a project plan of the project. The method can further comprise, after validating that the request is within the scope of the project and the project plan, determining, by the system, that funds for the request are available. The method can further comprise, after determining that the funds for the request are available, assigning, by the system, an accounting code and a general ledger cost account for the request. The method can further comprise, after assigning the accounting code, transacting, by the system, an order for the computing resources in an ordering system.

An example non-transitory computer-readable medium can comprise instructions that, in response to execution, cause a system comprising a processor to perform operations. These operations can comprise validating a program that corresponds to request data indicative of a request to acquire computing resources. These operations can further comprise, after validating the program, validating a configuration of hardware that corresponds to the request. These operations can further comprise, after validating the configuration, validating that the request is within a scope of a project. These operations can further comprise, after validating that the request is within the scope of the project, determining that funds for the request are available. These operations can further comprise, after determining that the funds for the request are available, assigning an accounting code for the request. These operations can further comprise, after assigning the accounting code, placing an order for the computing resources in an ordering system.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate a budget managing system, in accordance with an embodiment of this disclosure;

FIG. 2 illustrates an example process flow that can facilitate a budget managing system, in accordance with an embodiment of this disclosure;

FIG. 3 illustrates another example process flow that can facilitate a budget managing system, in accordance with an embodiment of this disclosure;

FIG. 4 illustrates another example process flow that can facilitate a budget managing system, in accordance with an embodiment of this disclosure;

FIG. 5 illustrates another example process flow that can facilitate a budget managing system, in accordance with an embodiment of this disclosure;

FIG. 6 illustrates an example process flow for validating a program and a budget that can facilitate a budget managing system, in accordance with an embodiment of this disclosure;

FIG. 7 illustrates an example process flow for validating a hardware configuration that can facilitate a budget managing system, in accordance with an embodiment of this disclosure;

FIG. 8 illustrates an example process flow for validating scope and project plans that can facilitate a budget managing system, in accordance with an embodiment of this disclosure;

FIG. 9 illustrates an example process flow from ordering from multiple ordering systems that can facilitate a budget managing system, in accordance with an embodiment of this disclosure;

FIG. 10 illustrates an example block diagram of a computer operable to execute an embodiment of this disclosure.

### DETAILED DESCRIPTION

### Overview

A problem can exist with processing a request to spend part of a budget on particular computer resources. Ensuring that proper validation and record-keeping is maintained for the request can be overly-complex, and unable to be processed manually due to at least the sheer amount of data involved—and particularly when multiple requests are being processed, leading to much inaccuracy and inefficiency.

An example could involve processing over 2,000 requests, where a request generally comprises more than one order of computing resources, and where each request has over 30 data points associated with it. In addition to being unviable to process this volume of requests manually, attempting to do so could lead to latency in generating executive reports so the data contained in those reports is stale. Furthermore, an attempt to manually process such orders could lead to other latency, such as with a long process cycle time and re-work delays with alignment for processing, which in some examples, could involve a greater than 21 business day approval process and a greater than 21 day order creation process.

A solution to this problem can be implemented with a budget managing computer that can proactively and automatically move request data through a set order of operations, and maintain tag data (which can be maintained as a value of a status for a request) efficiently in data structures that are associated with the request that identifies where request data is to be routed.

Yet another benefit of applying the present techniques can be to ensure that a set of operations are performed on request data in a set order so that an associated request is properly examined. This can be implemented to mitigate against failure points in the process, such as avoidance of over-using a budget, e.g., by externally fulfilling an order that can be fulfilled internally.

The present techniques can be implemented to provide a global real-time executive summary, where data is normalized, the process is transparent, currency conversions are implemented, and flexibility is provided. The present techniques can be implemented to normalize data so that it can be operated on, and a cloud-based implementation can facilitate these benefits.

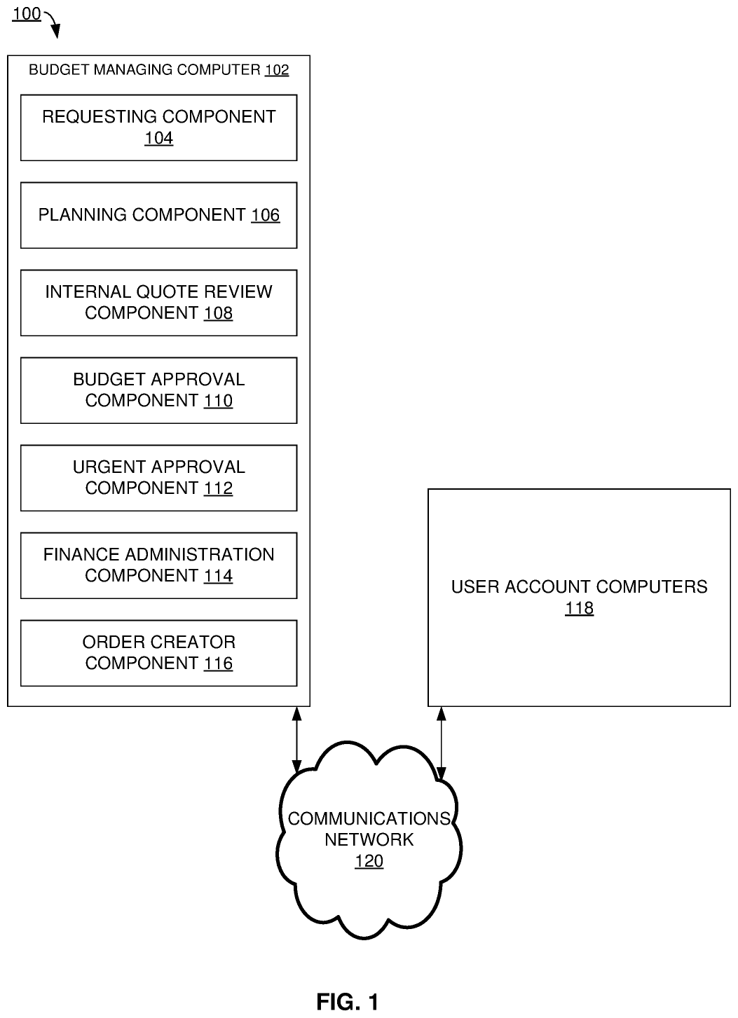

The present techniques can generally be implemented on computer systems, such as the example system architecture 100 of FIG. 1. It can be that the present techniques cannot properly be implemented manually by humans because the amount of data processing and synthesizing to track the status of a request across multiple validation stages can be too great to be performed manually (even where many people are involved, it can be that this does not cure the deficiencies of a manual approach, because no one person would have all of the information synthesized in a similar manner to how one computer component can have all of this information synthesized).

It can be a problem for customers to manage capital expenditures (CAPEX) and operating expenses (OPEX) in complex projects. Budgeting misses (a failure to stay within budget) can harm an organization's bottom line, while an absence of effective order management can lead to project timeline misses.

The present techniques can be implemented to meet budgetary constraints. The present techniques can implement a workflow and enforce user roles to ensure that purchase requests are properly aligned, reviewed, and advanced through a workflow as key milestones are met. In some examples, a requests is aligned with a specific project ID. This project alignment can facilitate budget managers quickly reviewing and properly estimating future spend based on many individually submitted requests. The present techniques can be implemented to improve planning, budget approval, finance approval, and ordering.

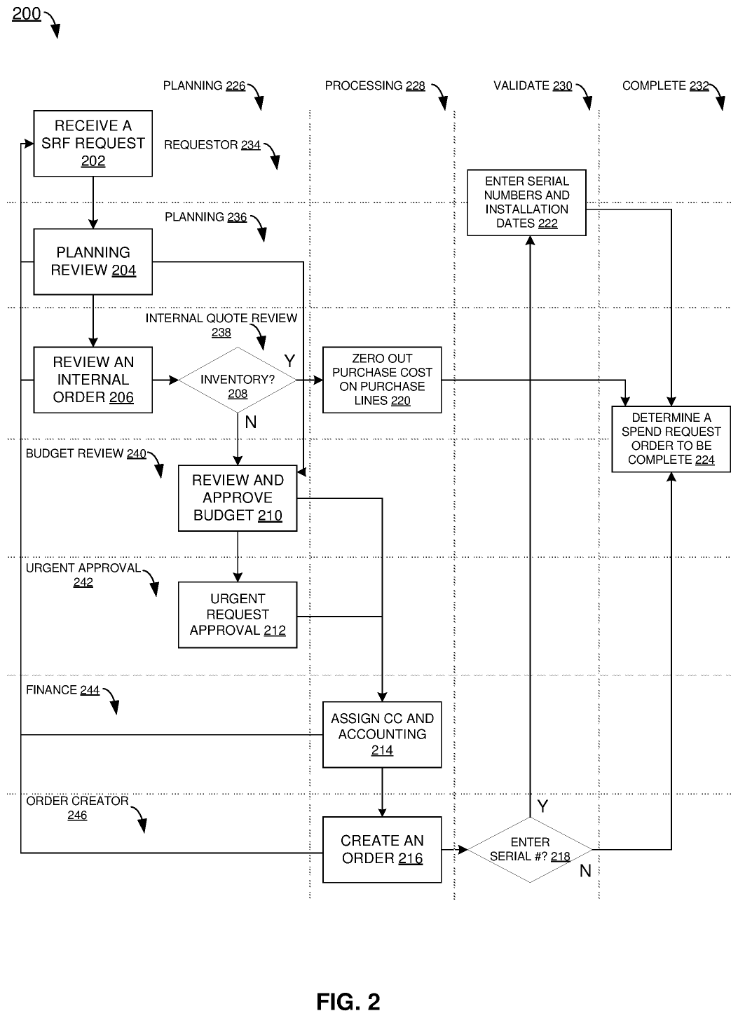

A request can be maintained as structured data that identifies various parts of the request (e.g., an identity of the requestor, one or more computer components that is requested, a date of the request, a budget associated with the request, etc.). As requests are routed through a budget managing system, such as according to process flow 200 of FIG. 2, different parts of a request can be presented in a user interface. For example, during operation 204 (planning review), parts of the request relating to planning review can be presented in a user interface. Then, during operation 210 (review and approve budget), parts of the request relating to reviewing and approving the budget can be presented in a user interface.

Prior techniques do not consider a combination of CAPEX, OPEX, information technology (IT) infrastructure systems, and project complexity.

In some examples according to the present techniques, a project can comprise four phases (planning, process, validation, and complete), and seven processes (request, plan, review quotes, budget review, urgent approvals if required, finance and accounting review, order creation) to facilitate gatekeeping, phase exit requirements, and role-based approval. This structure can also be implemented to ensure that budgeting and ordering accuracy is achieved in a complex IT project management that includes CAPEX and OPEX expenditures. This approach can decrease budget misses in managing complex IT projects.

The present techniques can also be implemented to ensure timely asset placement and accounting treatment prior to budget allocation and acquisition. This approach can mitigate against challenges like inbound hardware traffic jams (as well as mitigate against challenges like onboarding software project traffic jams). This approach can also mitigate against asset depreciation without utilization.

The present techniques can also be implemented to facilitate customers in directly utilizing a centralized process for managing complex projects that include multiple hardware, software, and services acquisition types. The present techniques can be implemented to create an interlock and look across processes to define when a project or process is done.

Prior techniques for infrastructure-as-a-service (IaaS) projects can generally assign a single user for signoff, and support only a single purchase type (such as cloud only, or equipment only). Limits can be set on cost, and multi-phased purchase processes are not supported. To manage complex IT projects according to the present techniques, clients manage complex infrastructure purchases through internal spend request form (SRF) forms, and email approval processes that are disconnected from an IaaS purchasing process.

The present techniques can be implemented to permit IaaS and other cloud and infrastructure vendors to understand and follow customers' internal processes.

The present techniques can be implemented to facilitate an engineering group to plan for future lab needs. Request data can be received for a data center environment. The request type can be determined as increasing capacity Expansion or Net New. Where hardware and components will be located can be determined. Whether the request is in alignment with the program/project can be determined. Whether there is budget alignment (increasing capacity or New New) can be determined. Whether the request corresponds to a proper cost and configuration (in terms of budget/design) can be determined. Whether the corresponding equipment will arrive on time (e.g., based on factory lead time/project schedule). Whether the equipment will have an installation location ready when it arrives can be determined.

Further using the future lab needs example, a design review can be performed (where design determines space allocation and cost/quote/review/validation/governance). A SRF can be received. Provisioning review can be performed. Budget approval can be performed. An ordering process can begin, and when equipment is delivered, an install can be planned. Once the equipment is installed, a close out can be performed.

### Example Architecture

FIG. 1 illustrates an example system architecture 100 that can facilitate a budget managing system, in accordance with an embodiment of this disclosure.

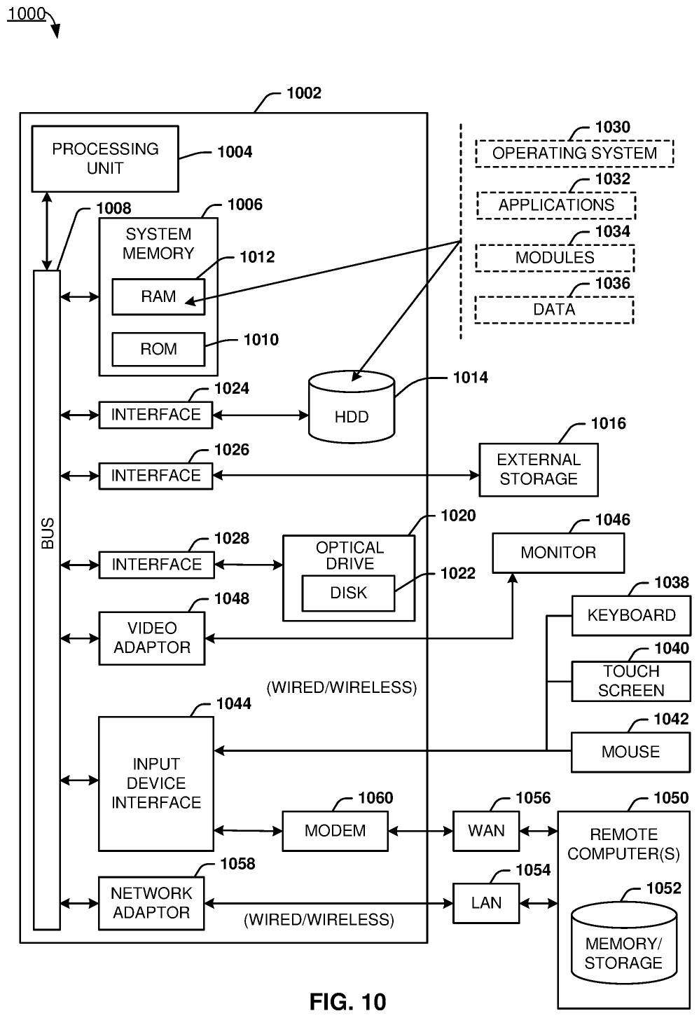

System architecture 100 can comprise budget managing computer 102 and user account computers 118. Each of budget managing computer 102 and user account computers 118 can be implemented with one or more instances of computer 1002 of FIG. 10.

Budget managing computer 102 comprises requesting component 104, planning component 106, internal quote review component 108, budget approval component 110, urgent approval component 112, finance administration component 114, and order creator component 116.

Requesting component 104 can implement functionality similar to that found in requestor 234 of FIG. 2. Planning component 106 can implement functionality similar that that found in planning review 236 of FIG. 2. Internal quote review component 108 can implement functionality similar to that found in quote review 238 of FIG. 2. Budget approval component 110. Urgent approval component 112 can implement functionality similar to that found in urgent approval 242 of FIG. 2. Finance administration component 114 can implement functionality similar to that found in finance 244 of FIG. 2. Order creator component 116 can implement functionality similar to that found in order creator 246 of FIG. 2.

Communications network 120 can comprise a computer communications network, such as the INTERNET.

Budget managing computer 102 and user account computers 118 can communicate via communications network 120. Budget managing computer 102 can route a request based on its tag to one or more user accounts associated with a particular operation in processing the request. These user accounts can be accessed at user account computers 118, which can receive corresponding user input data for the request that can be sent back to budget managing computer 102 for further processing of the request.

In facilitating a budget managing system, system architecture 100 can implement part(s) of the process flows of FIGS. 2-9.

### Example Process Flows

FIG. 2 illustrates an example process flow 200 that can facilitate a budget managing system, in accordance with an embodiment of this disclosure. In some examples, one or more embodiments of process flow 200 can be implemented by system architecture 100 of FIG. 1 or computing environment 1000 of FIG. 10.

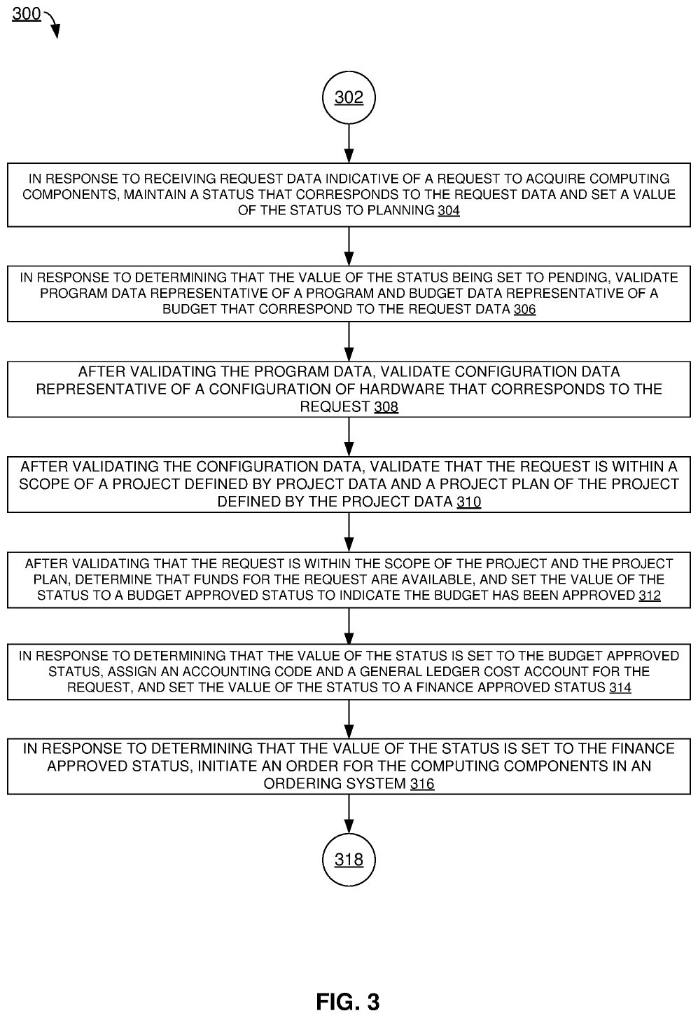

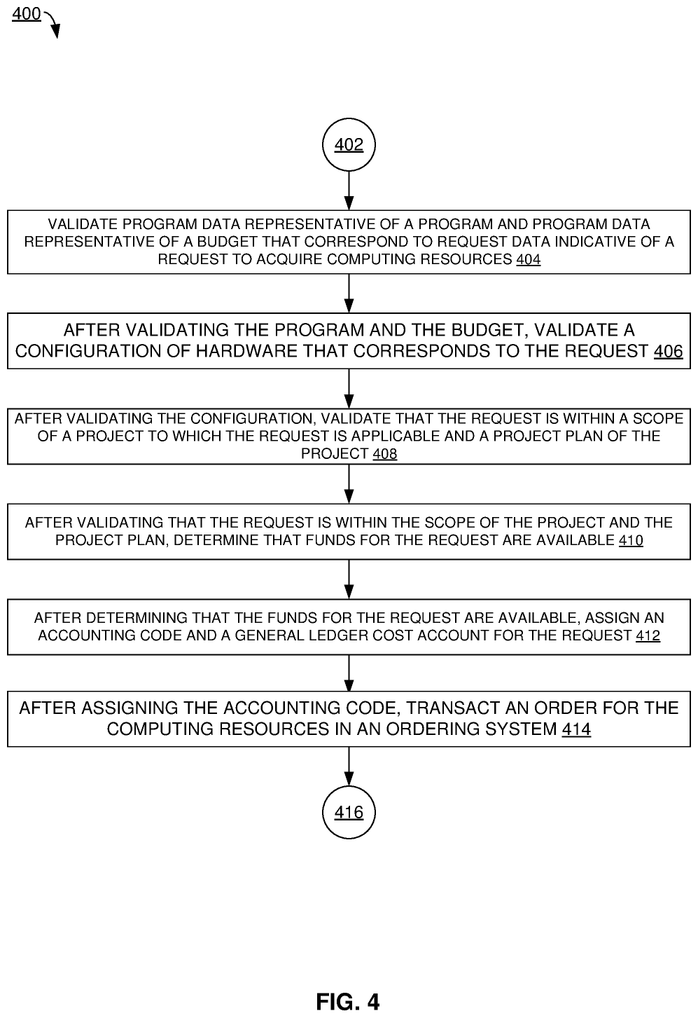

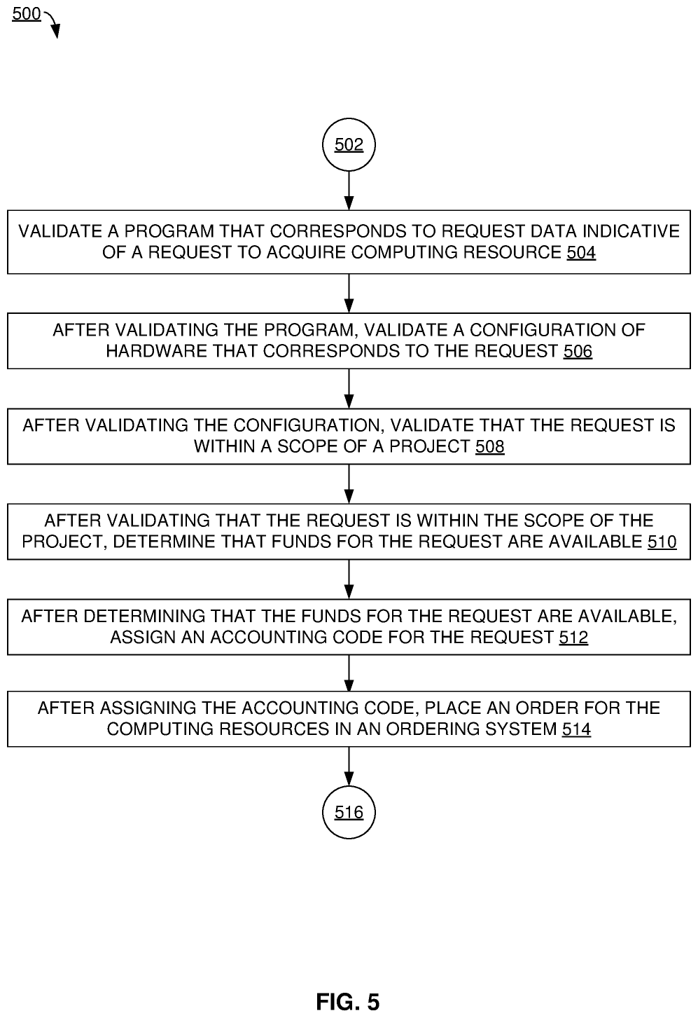

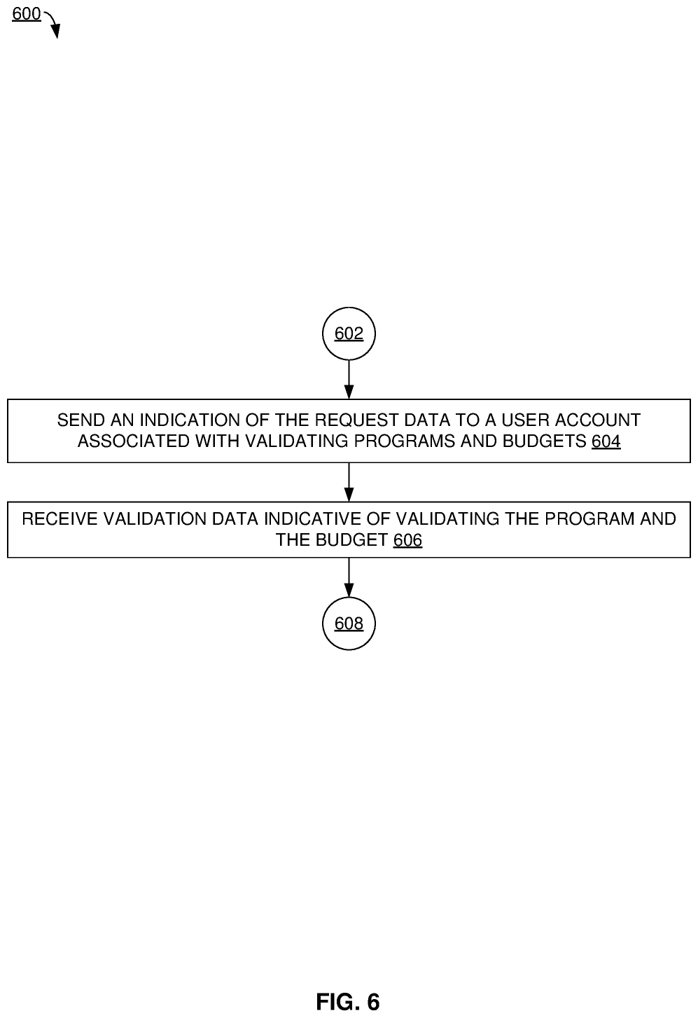

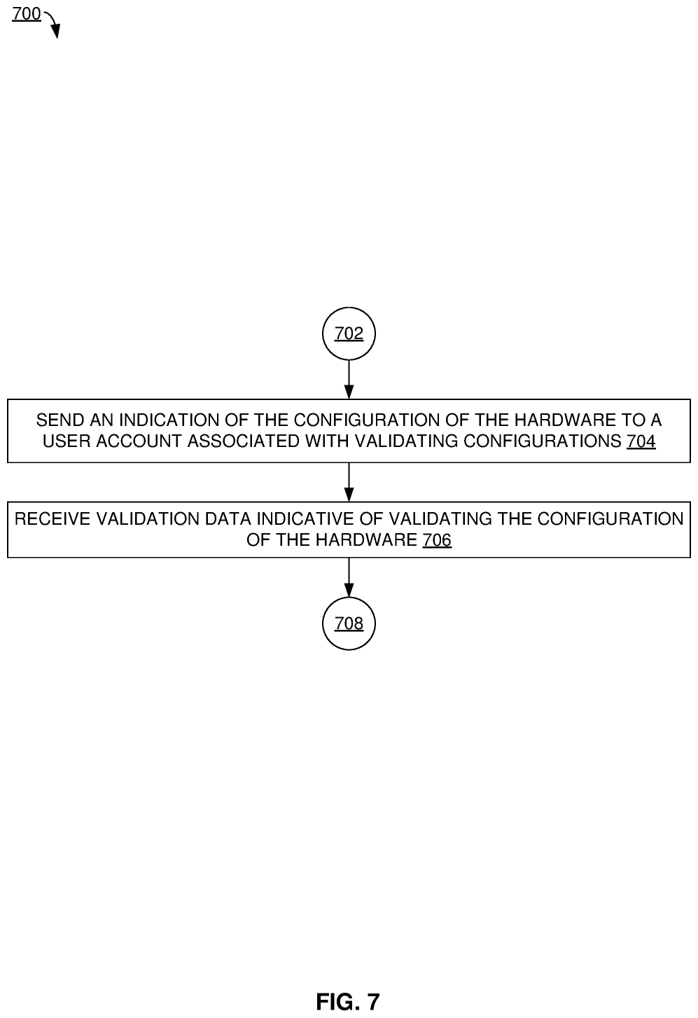

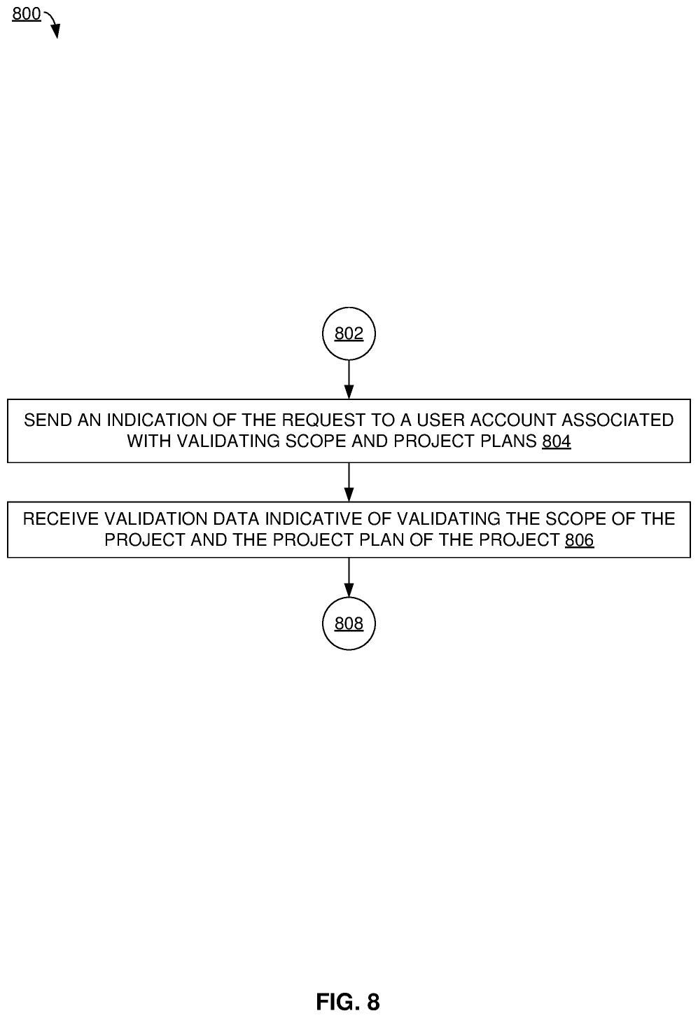

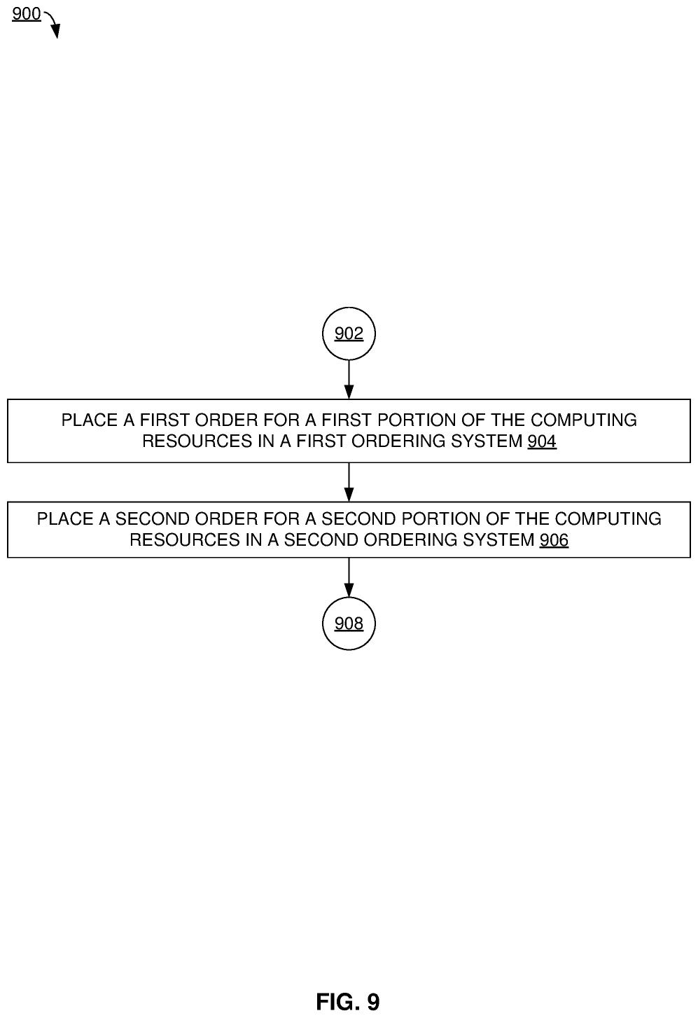

It can be appreciated that the operating procedures of process flow 200 are example operating procedures, and that there can be embodiments that implement more or fewer operating procedures than are depicted, or that implement the depicted operating procedures in a different order than as depicted. In some examples, process flow 200 can be implemented in conjunction with one or more embodiments of one or more of process flow 300 of FIG. 3, process flow 400 of FIG. 4, process flow 500 of FIG. 5, process flow 600 of FIG. 6, process flow 700 of FIG. 7, process flow 800 of FIG. 8, and/or process flow 900 of FIG. 9.

In process flow 200, a stepped workflow can be implemented. Columns of the stepped workflow can represent a phase of a project, and comprise planning 226, processing 228, validate 230, and complete 232.

Planning 226 can be where global road map and capacity expansion requests are gathered and reviewed for accuracy before they proceed to processing/ordering. Configurations can be validated, and budgets can be aligned to an annual operating plan.

Processing 228 can be where cost accounting codes are applied before orders are created in various ordering systems. A processing phase can be implemented to ensure that proper accounting treatments are assigned to permit accounting team members to quickly reconcile ledger entries.

Validate 230 can ensure that capital assets purchased have their serial numbers and installation dates recorded to begin their fixed asset depreciation in accounting sub-ledgers. A reconciliation process can occur monthly for purchased capital assets.

Complete 232 can be when a financial process is considered complete. That is, assets are installed, and asset depreciation can begin in fixed asset ledgers. A “request state” in an IT tool can be marked with a status that represents this complete state.

Rows of the stepped workflow can represent processes. Processes can occur once, or multiple times, in or across a phase.

Requestor 234 can comprise an entity that attempts to spend CAPEX or OPEX for a project. Requests created can be aligned to a project budget, and flow to review and advancement, such as from review data received from a planning person.

Planning review 236 can comprise a first vetting stage of a spend request that is submitted by a global requester, and can be implemented to ensure that requests are aligned to a proper program and budget. Spend requests can be directed to particular user accounts associated with people performing planning duties who are assigned to specific programs within their work scope, and who can have knowledge of a business case that supports a spend request.

Quote review 238 can comprise a sub-process within a planning phase where a spend request is routed for configuration validation review. Once a configuration is approved as true and correct, the configuration can be routed to a user account associated with a budget manager.

Budget review 240 can comprise a sub-process within planning. Budget review data can be received that indicates that a request is in alignment to an approved program and that project plans and needed funds are available.

Urgent approval 242 can comprise an emergency or executive escalation pathway to ensure that emergencies are fast tracked through to order creation. A request for urgent approval can be routed to a user account associated with a director level leader, from which approval data can be received.

Finance 244 can assign correct accounting codes/treatments and general ledger cost accounts (e.g., which entity is paying) for a purchase processed. This can ensure that end-of-period (e.g., end-of-month) reconciliation is fast and efficient.

Order creator 246 can comprise placing an order into an ordering system and notify a requestor when its order is complete so that the requestor can monitor for delivery and installation.

The present techniques can be implemented to enable complex ordering management and process enablement through a streamlined workflow.

Process flow 200 can begin with operation 202. Operation 202 depicts receiving a SRF request. In some examples, operation 202 can be reached from an initial SRF request, or from operation 206, operation 210, operation 214, or operation 216 where a current request is rejected at that operation (and the request's status can be set to “rejected”).

A request can be received from user input data indicative of a request to make a spend request order. Where a request is rejected, as part of operation 202, an indication of the request can be sent to a user account associated with a person who created the original request, and user input data can be received that is indicative of a revised request to make a spend request order.

In some examples, operation 202 can comprise normalizing data—e.g., ensuring that data corresponding to a SRF request is contained in a common format among SRF requests. In some examples, this normalizing can be effectuated by providing a user interface for receiving order data, where fields of the user interface are specified for receiving different parts of data of the request. Additionally, normalizing the data can comprise enforcing constraints on the data, such as ensuring that a certain user input field receives a number for input data, or that input data received at another user input field identifies a valid budget.

During operation 202, a status of the request can be set to “composing.” At a conclusion of operation 202, a status of the request can be set to “planning,” and process flow 200 can move to operation 204.

Operation 204 depicts planning review. Where planning review indicates that the order is for internal resources (e.g., hardware or software that the entity that implements a budget managing system itself provides), the status of the request can be set to “provisioning review,” and process flow 200 can move to operation 206. An order can be determined to be for internal resources where the request specifies an expense type ID that identifies the internal entity.

Instead (e.g., where planning review does not indicate that the order is for internal resources), the status of the request can be set to “planning complete,” and process flow 200 can move to operation 210.

Operation 206 is reached from operation 204 where it is determined that the order is for internal resources. Operation 206 depicts reviewing an internal order. Where the internal order is rejected, process flow 200 can return to operation 202, with the status of the request set to “rejected.” Otherwise, process flow 200 moves to operation 208.

Operation 208 depicts determining whether the order will be fulfilled from inventory. This can be inventory possessed by an entity associated with the requestor that is not otherwise reserved for another project.

Where it is determined in operation 208 that the order will be fulfilled from inventory, a status of the request can be set to “complete,” and process flow 200 can move to operation 220. Instead, where it is determined in operation 208 that the order will not be fulfilled from inventory, a status of the request can be set to “review complete,” and process flow 200 can move to operation 210. In some examples, an order can be partially filled from inventory, and this can be considered not to be fully fulfilled from inventory, so process flow 200 can move to operation 210.

Operation 210 is reached from operation 204 where it is determined that the order is not for internal resources, or from operation 208 where it is determined that the order will not be fulfilled from inventory. Operation 210 depicts reviewing and approving budget.

Where the budget is not approved, the status of the request can be set to “rejected,” and process flow 200 can return to operation 202. Where the budget is approved, and not deemed to be urgent, process flow 200 can move to operation 214, and the status of the request can be set to “budget approved.” Where the budget is approved and deemed to be urgent, process flow 200 can move to operation 212.

Operation 212 is reached from operation 210 where the budget is approved and deemed to be urgent. Operation 212 depicts urgent request approval. This can comprise a budget associated with a project that is associated with the request. Where an additional approval is made in operation 212 regarding the urgent approval, the status of the request can be set to “budget approved,” and process flow 200 can move to operation 214.

Operation 214 is reached from operation 210 where the budget is approved and deemed not to be urgent, or from operation 212 where the urgent approval for the budget is granted. Operation 214 depicts assigning cost center (CC) and accounting. This can be CC and accounting that relates to the request, and can include setting a flag for the request that identifies whether one or more serial numbers are to be entered for items related to the order.

In some examples, organizations can be assigned respective CCs to track their expenditures. A CC can be part of a text string that identifies a legal entity, business unit, and cost center, such as 1001-2010-770023. In this example, 1001 can identify a legal entity, 2010 can identify a business unit, and 770023 can identify a cost center. A CC can determine a tax jurisdiction, and can be different for each country, location, and leader. CCs can be used to code transactions so that they can be reconciled quickly. For example, when CCs are maintained, capital expenditures can be coded to begin with 16###, and operating expenses can start with 6####.

Where the act of assigning CCs and accounting for the request is rejected, the status of the request can be set to “rejected,” and process flow 200 can return to operation 202. Otherwise, the status of the request can be set to “finance approved,” and process flow 200 moves to operation 216.

Operation 216 depicts creating an order. This can comprise ordering one or more computing resources associated with the order from one or more ordering systems from which computing resources can be ordered. Where the act of creating the order is rejected, the status of the request can be set to “rejected,” and process flow 200 can return to operation 202. Otherwise, process flow 200 moves to operation 218.

Operation 218 depicts determining whether a serial number is required. This can comprise checking whether a flag indicating that one or more serial numbers for the request is required was set in operation 214. Where it is determined that a serial number is required, the status of the request can be set to “ordered,” and process flow 200 moves to operation 222. Where it is determined that a serial number is not required, the status of the request can be set to “complete,” and process flow 200 moves to operation 224.

Operation 220 is reached from operation 208 where it is determined that the order will be filled from inventory. Operation 220 depicts zeroing out purchase cost on purchase lines. This can indicate that there is not an additional cost associated with fulfilling the order beyond the internally-fulfilled aspect of the order. After operation 220, process flow 200 moves to operation 224.

Operation 222 is reached from operation 220 where it is determined that a serial number is required. Operation 222 depicts entering serial numbers and installation dates. After operation 222, the status of the request can be set to “complete,” and process flow 200 can move to operation 224.

Operation 224 can be reached from operation 218 where it is determined that a serial number is not required, from operation 220, or from operation 222. Operation 224 depicts determining a spend request order to be complete. That is, when process flow 200 reaches operation 224, the request that originated in operation 202 can be fulfilled.

FIG. 3 illustrates another example process flow 300 that can facilitate a budget managing system, in accordance with an embodiment of this disclosure. In some examples, one or more embodiments of process flow 300 can be implemented by system architecture 100 of FIG. 1 or computing environment 1000 of FIG. 10.

It can be appreciated that the operating procedures of process flow 300 are example operating procedures, and that there can be embodiments that implement more or fewer operating procedures than are depicted, or that implement the depicted operating procedures in a different order than as depicted. In some examples, process flow 300 can be implemented in conjunction with one or more embodiments of one or more of process flow 200 of FIG. 2, process flow 400 of FIG. 4, process flow 500 of FIG. 5, process flow 600 of FIG. 6, process flow 700 of FIG. 7, process flow 800 of FIG. 8, and/or process flow 900 of FIG. 9.

Process flow 300 begins with 302, and moves to operation 304. Operation 304 depicts, in response to receiving request data indicative of a request to acquire computing components, maintaining a status that corresponds to the request data and setting a value of the status to planning In some examples, operation 304 can be implemented in a similar manner as operation 202 of FIG. 2.

After operation 304, process flow 300 moves to operation 306.

Operation 306 depicts, in response to determining that the value of the status being set to pending, validating program data representative of a program and budget data representative of a budget that correspond to the request data. In some examples, operation 306 can be implemented in a similar manner as operation 204 of FIG. 2.

After operation 306, process flow 300 moves to operation 308.

Operation 308 depicts, after validating the program data, validating configuration data representative of a configuration of hardware that corresponds to the request. In some examples, operation 308 can be implemented in a similar manner as operation 206 of FIG. 2.

After operation 308, process flow 300 moves to operation 310.

Operation 310 depicts, after validating the configuration data, validating that the request is within a scope of a project defined by project data and a project plan of the project defined by the project data. In some examples, operation 310 can be implemented in a similar manner as operation 210 of FIG. 2.

After operation 310, process flow 300 moves to operation 312.

Operation 312 depicts, after validating that the request is within the scope of the project and the project plan, determining that funds for the request are available, and setting the value of the status to a budget approved status to indicate the budget has been approved. In some examples, operation 312 can be implemented in a similar manner as operation 210 of FIG. 2.

In some examples, the request data is first request data, and operation 312 comprises, in response to determining that the first request data is associated with an urgent status, expediting a first speed of determining that the funds for the request are available relative to a second speed associated with second request data that is applicable without the urgent status. In some examples, this can be implemented in a similar manner as operation 212 of FIG. 2.

In some examples, the request is a first request, the funds are first funds, determining that the first funds for the first request are available comprises routing the first request to a first user account, and determining that second funds for the second request are available comprises routing the second request to a second user account. That is, urgent approvals can be routed differently within a computer system as compared to non-urgent approvals.

After operation 312, process flow 300 moves to operation 314.

Operation 314 depicts, in response to determining that the value of the status is set to the budget approved status, assigning an accounting code and a general ledger cost account for the request, and setting the value of the status to a finance approved status. In some examples, operation 314 can be implemented in a similar manner as operation 214 of FIG. 2.

In some examples, the general ledger cost account identifies an entity that is paying a bill associated with the request.

After operation 314, process flow 300 moves to operation 316.

Operation 316 depicts, in response to determining that the value of the status is set to the finance approved status, initiating an order for the computing components in an ordering system. In some examples, operation 316 can be implemented in a similar manner as operation 216 of FIG.

After operation 316, process flow 300 moves to 318, where process flow 300 ends.

FIG. 4 illustrates another example process flow 400 that can facilitate a budget managing system, in accordance with an embodiment of this disclosure. In some examples, one or more embodiments of process flow 400 can be implemented by system architecture 100 of FIG. 1 or computing environment 1000 of FIG. 10.

It can be appreciated that the operating procedures of process flow 400 are example operating procedures, and that there can be embodiments that implement more or fewer operating procedures than are depicted, or that implement the depicted operating procedures in a different order than as depicted. In some examples, process flow 400 can be implemented in conjunction with one or more embodiments of one or more of process flow 200 of FIG. 2, process flow 300 of FIG. 3, process flow 500 of FIG. 5, process flow 600 of FIG. 6, process flow 700 of FIG. 7, process flow 800 of FIG. 8, and/or process flow 900 of FIG. 9.

Process flow 400 begins with 402, and moves to operation 404. Operation 404 depicts validating program data representative of a program and program data representative of a budget that correspond to request data indicative of a request to acquire computing resources. In some examples, operation 404 can be implemented in a similar manner as operation 306 of FIG. 3.

In some examples, operation 404 comprises maintaining a status associated with the request, wherein the status indicates an amount of completeness of processing the request data.

After operation 404, process flow 400 moves to operation 406.

Operation 406 depicts, after validating the program and the budget, validating a configuration of hardware that corresponds to the request. In some examples, operation 406 can be implemented in a similar manner as operation 308 of FIG. 3.

In some examples, operation 406 comprises, in response to determining that the computer resources are for an internal order, setting a status associated with the request to provisioning review. This can be implemented in a similar manner as operation 206 of FIG. 2, and used to identify internal orders.

In some examples, operation 406 comprises, in response to determining that the computing resources can be fulfilled from internal inventory, zeroing out purchase costs on purchase lines associated with the request data. That is, where the internal order can be fulfilled from existing inventory, then purchase costs on purchase lines can be set to zero.

In some examples, operation 406 comprises, in response to determining that the computing resources cannot be fulfilled from internal inventory, setting a status associated with the request to review complete. That is, when an internal order will not be filled from existing inventory, then the request's status can be set to review complete.

After operation 406, process flow 400 moves to operation 408.

Operation 408 depicts, after validating the configuration, validating that the request is within a scope of a project to which the request is applicable and a project plan of the project. In some examples, operation 408 can be implemented in a similar manner as operation 310 of FIG. 3.

After operation 408, process flow 400 moves to operation 410.

Operation 410 depicts, after validating that the request is within the scope of the project and the project plan, determining that funds for the request are available. In some examples, operation 410 can be implemented in a similar manner as operation 312 of FIG. 3.

After operation 410, process flow 400 moves to operation 412.

Operation 412 depicts, after determining that the funds for the request are available, assigning an accounting code and a general ledger cost account for the request. In some examples, operation 412 can be implemented in a similar manner as operation 314 of FIG. 3.

After operation 412, process flow 400 moves to operation 414.

Operation 414 depicts, after assigning the accounting code, transacting an order for the computing resources in an ordering system. In some examples, operation 414 can be implemented in a similar manner as operation 316 of FIG. 3.

In some examples, operation 414 comprises storing a serial number associated with the computing resources. In some examples, this can be implemented in a similar manner as operation 222 of FIG. 2. In some examples, operation 414 comprises storing an installation date associated with the computing resources. In some examples, this can be implemented in a similar manner as operation 222 of FIG. 2.

After operation 414, process flow 400 moves to 416, where process flow 400 ends.

FIG. 5 illustrates another example process flow 500 that can facilitate a budget managing system, in accordance with an embodiment of this disclosure. In some examples, one or more embodiments of process flow 500 can be implemented by system architecture 100 of FIG. 1 or computing environment 1000 of FIG. 10.

It can be appreciated that the operating procedures of process flow 500 are example operating procedures, and that there can be embodiments that implement more or fewer operating procedures than are depicted, or that implement the depicted procedures in a different order than as depicted. In some examples, process flow 500 can be implemented in conjunction with one or more embodiments of one or more of process flow 200 of FIG. 2, process flow 300 of FIG. 3, process flow 400 of FIG. 4, process flow 600 of FIG. 6, process flow 700 of FIG. 7, process flow 800 of FIG. 8, and/or process flow 900 of FIG. 9.

Process flow 500 begins with 502, and moves to operation 504. Operation 504 depicts validating a program that corresponds to request data indicative of a request to acquire computing resource. In some examples, operation 504 can be implemented in a similar manner as operation 306 of FIG. 3. In some examples, operation 504 comprises validating a budget that corresponds to the request data.

After operation 504, process flow 500 moves to operation 506.

Operation 506 depicts, after validating the program, validating a configuration of hardware that corresponds to the request. In some examples, operation 506 can be implemented in a similar manner as operation 308 of FIG. 3.

After operation 506, process flow 500 moves to operation 508.

Operation 508 depicts, after validating the configuration, validating that the request is within a scope of a project. In some examples, operation 508 can be implemented in a similar manner as operation 310 of FIG. 3. In some examples, operation 508 can comprise validating that the request is within the scope of a project plan of the project.

After operation 508, process flow 500 moves to operation 510.

Operation 510 depicts, after validating that the request is within the scope of the project, determining that funds for the request are available. In some examples, operation 510 can be implemented in a similar manner as operation 312 of FIG. 3.

After operation 510, process flow 500 moves to operation 512.

Operation 512 depicts, after determining that the funds for the request are available, assigning an accounting code for the request. In some examples, operation 512 can be implemented in a similar manner as operation 314 of FIG. 3. In some examples, operation 512 comprises assigning a general ledger cost account for the request. In some examples, operation 512 comprises assigning an accounting treatment for the request.

After operation 512, process flow 500 moves to operation 514.

Operation 514 depicts, after assigning the accounting code, placing an order for the computing resources in an ordering system. In some examples, operation 514 can be implemented in a similar manner as operation 316 of FIG. 3.

After operation 514, process flow 500 moves to 516, where process flow 500 ends.

FIG. 6 illustrates an example process flow 600 for validating a program and a budget that can facilitate a budget managing system, in accordance with an embodiment of this disclosure. In some examples, one or more embodiments of process flow 600 can be implemented by system architecture 100 of FIG. 1 or computing environment 1000 of FIG. 10.

It can be appreciated that the operating procedures of process flow 600 are example operating procedures, and that there can be embodiments that implement more or fewer operating procedures than are depicted, or that implement the depicted procedures in a different order than as depicted. In some examples, process flow 600 can be implemented in conjunction with one or more embodiments of one or more of process flow 200 of FIG. 2, process flow 300 of FIG. 3, process flow 400 of FIG. 4, process flow 500 of FIG. 5, process flow 700 of FIG. 7, process flow 800 of FIG. 8, and/or process flow 900 of FIG. 9.

Process flow 600 begins with 602, and moves to operation 604. Operation 604 depicts sending an indication of the request data to a user account associated with validating programs and budgets. That is, request data can be routed within a system to the user account of someone who is responsible with validating programs and budgets. This routing can be performed based on a current tag of the request, and based on a list of user accounts that are associated with validating programs and budgets that are stored in a computer memory. In some examples, this routing can comprise sending an email that indicates that there is a request to be validated.

After operation 604, process flow 600 moves to operation 606.

Operation 606 depicts receiving validation data indicative of validating the program and the budget. That is, user input data can be received via the user account that is indicative of the program and budget being validated (or rejected). For example, a budget managing system can provide a user interface that accepts user input data indicative of validating or rejecting a request, and this user interface can be presented to a computer to which the user account is logged in, or otherwise active.

After operation 606, process flow 600 moves to 608, where process flow 600 ends.

FIG. 7 illustrates an example process flow 700 for validating a hardware configuration that can facilitate a budget managing system, in accordance with an embodiment of this disclosure. In some examples, one or more embodiments of process flow 700 can be implemented by system architecture 100 of FIG. 1 or computing environment 1000 of FIG. 10.

It can be appreciated that the operating procedures of process flow 700 are example operating procedures, and that there can be embodiments that implement more or fewer operating procedures than are depicted, or that implement the depicted procedures in a different order than as depicted. In some examples, process flow 700 can be implemented in conjunction with one or more embodiments of one or more of process flow 200 of FIG. 2, process flow 300 of FIG. 3, process flow 400 of FIG. 4, process flow 500 of FIG. 5, process flow 600 of FIG. 6, process flow 800 of FIG. 8, and/or process flow 900 of FIG. 9.

Process flow 700 begins with 702, and moves to operation 704. Operation 704 depicts sending an indication of the configuration of the hardware to a user account associated with validating configurations. That is, request data can be routed within a system to the user account of someone who is responsible with validating hardware configurations. This routing can be performed based on a current tag of the request, and based on a list of user accounts that are associated with validating hardware configurations that are stored in a computer memory. In some examples, this routing can comprise sending an email that indicates that there is a request to be validated.

After operation 704, process flow 700 moves to operation 706.

Operation 706 depicts receiving validation data indicative of validating the configuration of the hardware. That is, user input data can be received via the user account that is indicative of the hardware configuration being validated (or rejected). For example, a budget managing system can provide a user interface that accepts user input data indicative of validating or rejecting a request, and this user interface can be presented to a computer to which the user account is logged in, or otherwise active.

After operation 706, process flow 700 moves to 708, where process flow 700 ends.

FIG. 8 illustrates an example process flow 800 for validating scope and project plans that can facilitate a budget managing system, in accordance with an embodiment of this disclosure. In some examples, one or more embodiments of process flow 800 can be implemented by system architecture 100 of FIG. 1 or computing environment 1000 of FIG. 10.

It can be appreciated that the operating procedures of process flow 800 are example operating procedures, and that there can be embodiments that implement more or fewer operating procedures than are depicted, or that implement the depicted procedures in a different order than as depicted. In some examples, process flow 800 can be implemented in conjunction with one or more embodiments of one or more of process flow 200 of FIG. 2, process flow 300 of FIG. 3, process flow 400 of FIG. 4, process flow 500 of FIG. 5, process flow 600 of FIG. 6, process flow 700 of FIG. 7, and/or process flow 900 of FIG. 9.

Process flow 800 begins with 802, and moves to operation 804. Operation 804 depicts sending an indication of the request to a user account associated with validating scope and project plans. That is, request data can be routed within a system to the user account of someone who is responsible with validating scope and project plans. This routing can be performed based on a current tag of the request, and based on a list of user accounts that are associated with validating scope and project plans that are stored in a computer memory. In some examples, this routing can comprise sending an email that indicates that there is a request to be validated.

After operation 804, process flow 800 moves to operation 806.

Operation 806 depicts receiving validation data indicative of validating the scope of the project and the project plan of the project. That is, user input data can be received via the user account that is indicative of the scope and project plan being validated (or rejected). For example, a budget managing system can provide a user interface that accepts user input data indicative of validating or rejecting a request, and this user interface can be presented to a computer to which the user account is logged in, or otherwise active.

After operation 806, process flow 800 moves to 808, where process flow 800 ends.

FIG. 9 illustrates an example process flow 900 for ordering from multiple ordering systems that can facilitate a budget managing system, in accordance with an embodiment of this disclosure. In some examples, one or more embodiments of process flow 900 can be implemented by system architecture 100 of FIG. 1 or computing environment 1000 of FIG. 10.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 200 of FIG. 2, process flow 300 of FIG. 3, process flow 400 of FIG. 4, process flow 500 of FIG. 5, process flow 600 of FIG. 6, process flow 700 of FIG. 7, and/or process flow 800 of FIG. 8.

Process flow 900 begins with 902, and moves to operation 904. Operation 904 depicts placing a first order for a first portion of the computing resources in a first ordering system. That is, an order can comprise computing resources from multiple sources, which use separate ordering systems. In such examples, a determination can be made of which portions of an order are associated with which ordering system (such as by evaluating one or more manufacturer or vendor IDs associated with the request, where a stored association is maintained between those IDs and respective ordering systems). Where a determination is made of which portions of an order are associated with which ordering system, a first portion of the order associated with a first ordering system can be made via the first ordering system.

After operation 904, process flow 900 moves to operation 906.

Operation 906 depicts placing a second order for a second portion of the computing resources in a second ordering system. Similar to operation 906, where a determination is made of which portions of an order are associated with which ordering system, a second portion of the order associated with a second ordering system can be made via the second ordering system.

After operation 906, process flow 900 moves to 908, where process flow 900 ends.

### Example Operating Environment

In order to provide additional context for various embodiments described herein, FIG. 10 and the following discussion are intended to provide a brief, general description of a suitable computing environment 1000 in which the various embodiments of the embodiment described herein can be implemented.

For example, parts of computing environment 1000 can be used to implement one or more embodiments of budget managing computer 102 and user account computers 118 of FIG. 1.

In some examples, computing environment 1000 can implement one or more embodiments of the process flows of FIGS. 2-9 to facilitate a budget managing system.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a nonvolatile storage such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1094 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enable with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1094 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “data store,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a processor; and
a memory that stores executable instructions that, when executed by the processor, facilitate performance of operations, comprising:
in response to receiving request data indicative of a request to acquire computing components, maintaining a status that corresponds to the request data and setting a value of the status to planning;
in response to determining that the value of the status being set to pending, validating program data representative of a program and budget data representative of a budget that correspond to the request data;
after validating the program data, validating configuration data representative of a configuration of hardware that corresponds to the request;
after validating the configuration data, validating that the request is within a scope of a project defined by project data and a project plan of the project defined by the project data;
after validating that the request is within the scope of the project and the project plan, determining that funds for the request are available, and setting the value of the status to a budget approved status to indicate the budget has been approved;
in response to determining that the value of the status is set to the budget approved status, assigning an accounting code and a general ledger cost account for the request, and setting the value of the status to a finance approved status; and
in response to determining that the value of the status is set to the finance approved status, initiating an order for the computing components in an ordering system.

2. The system of claim 1, wherein the request data is first request data, and wherein the operations further comprise:
in response to determining that the first request data is associated with an urgent status, expediting a first speed of determining that the funds for the request are available relative to a second speed associated with second request data that is applicable without the urgent status.

3. The system of claim 2, wherein the request is a first request,
wherein the funds are first funds,
wherein determining that the first funds for the first request are available comprises routing the first request to a first user account, and
wherein determining that second funds for the second request are available comprises routing the second request to a second user account.

4. The system of claim 1, wherein validating the program data and the budget data that correspond to the request data comprises:
sending an indication of the request data to a user account associated with validating programs and budgets; and
receiving validation data indicative of validating the program and the budget.

5. The system of claim 1, wherein validating the configuration of the hardware comprises:
sending an indication of the configuration of the hardware to a user account associated with validating configurations; and
receiving validation data indicative of validating the configuration of the hardware.

6. The system of claim 1, wherein validating that the request is within the scope of the project and the project plan of the project comprises:
sending an indication of the request to a user account associated with validating scope and project plans; and
receiving validation data indicative of validating the scope of the project and the project plan of the project.

7. The system of claim 1, wherein the general ledger cost account identifies an entity that is paying a bill associated with the request.

8. A method, comprising:
validating, by a system comprising a processor, program data representative of a program and program data representative of a budget that correspond to request data indicative of a request to acquire computing resources;
after validating the program and the budget, validating, by the system, a configuration of hardware that corresponds to the request;
after validating the configuration, validating, by the system, that the request is within a scope of a project to which the request is applicable and a project plan of the project;
after validating that the request is within the scope of the project and the project plan, determining, by the system, that funds for the request are available;
after determining that the funds for the request are available, assigning, by the system, an accounting code and a general ledger cost account for the request; and
after assigning the accounting code, transacting, by the system, an order for the computing resources in an ordering system.

9. The method of claim 8, further comprising:
storing, by the system, a serial number associated with the computing resources.

10. The method of claim 8, further comprising:
storing, by the system, an installation date associated with the computing resources.

11. The method of claim 8, further comprising:
in response to determining that the computer resources are for an internal order, setting, by the system, a status associated with the request to provisioning review.

12. The method of claim 11, further comprising:
in response to determining that the computing resources can be fulfilled from internal inventory, zeroing out, by the system, purchase costs on purchase lines associated with the request data.

13. The method of claim 11, further comprising:
in response to determining that the computing resources cannot be fulfilled from internal inventory, setting, by the system, a status associated with the request to review complete.

14. The method of claim 8, further comprising:
maintaining, by the system, a status associated with the request, wherein the status indicates an amount of completeness of processing the request data.

15. A non-transitory computer-readable medium comprising instructions that, in response to execution, cause a system comprising a processor to perform operations, comprising:
validating a program that corresponds to request data indicative of a request to acquire computing resources;
after validating the program, validating a configuration of hardware that corresponds to the request;
after validating the configuration, validating that the request is within a scope of a project;
after validating that the request is within the scope of the project, determining that funds for the request are available;
after determining that the funds for the request are available, assigning an accounting code for the request; and
after assigning the accounting code, placing an order for the computing resources in an ordering system.

16. The non-transitory computer-readable medium of claim 15, wherein validating that the request is within the scope of the project comprises:
validating that the request is within the scope of a project plan of the project.

17. The non-transitory computer-readable medium of claim 15, wherein assigning the accounting code for the request comprises:
assigning a general ledger cost account for the request.

18. The non-transitory computer-readable medium of claim 15, wherein assigning the accounting code for the request comprises:
assigning an accounting treatment for the request.

19. The non-transitory computer-readable medium of claim 15, wherein validating the program that corresponds to request data comprises:
validating a budget that corresponds to the request data.

20. The non-transitory computer-readable medium of claim 15, wherein placing the order for the computing resources in the ordering system comprises:
placing a first order for a first portion of the computing resources in a first ordering system; and
placing a second order for a second portion of the computing resources in a second ordering system.
